(19) United States
(12) Patent Application Publication
(10) Pub. No.: US 2012/0314693 A1
(43) Pub. Date: Dec. 13, 2012

(54) Method and System of Operating a Hotspot Application in a Wireless Device

(75) Inventors: Kamesh Medapalli, San Jose, CA (US); Sanjay Saha, Bangalore (IN)

(73) Assignee: Broadcom Corporation, Irvine, CA (US)

(21) Appl. No.: 13/478,924

(22) Filed: May 23, 2012

Related U.S. Application Data
(60) Provisional application No. 61/494,838, filed on Jun. 8, 2011.

(51) Int. Cl. H04W 40/00; H04W 84/12

(52) U.S. Cl. 370/338; 370/328

(57) ABSTRACT

Embodiments for processing client traffic in a wireless device operated in hotspot mode are provided. Embodiments enable downlink and uplink client traffic flows within the wireless device that reduce the load on the application processor (AP) of the wireless device. In an embodiment, client traffic flows bypass the AP entirely allowing the AP to enter a power saving mode during hotspot sessions. This results in increased battery lifetime and reduced power consumption of the wireless device. In addition, the hotspot session quality is improved by the reduced latency resulting from bypassing the AP.

### CROSS-REFERENCE TO RELATED APPLICATIONS

The present application claims the benefit of U.S. Provisional Patent Application No. 61/494,838 filed on Jun. 8, 2011, which is incorporated herein by reference in its entirety.

### BACKGROUND

1. Field of the Invention

The present disclosure relates generally to processing packets in wireless communication devices.

2. Background Art

Wireless communications devices, such as smart phones, for example, may be operated either in a Station mode or in a Hotspot mode (access point). Commonly, Hotspot mode operation relies heavily on the application processor (AP) of the wireless communications device, which both reduces the battery lifetime and increases latency within the wireless communications device.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 illustrates an example wireless communications device according to an embodiment of the present disclosure.

FIG. 2 illustrates another example wireless communications device according to an embodiment of the present disclosure.

FIG. 3 illustrates an example wireless communications integrated circuit (IC) according to an embodiment of the present disclosure.

FIG. 4 illustrates an example implementation of embodiments of the present disclosure.

FIG. 5 is a process flowchart of a method of processing packets in a wireless communications device according to an embodiment of the present disclosure.

FIG. 6 illustrates an example computer system that can be used to implement aspects of the present disclosure.

The present disclosure will be described with reference to the accompanying drawings. Generally, the drawing in which an element first appears is typically indicated by the leftmost digit(s) in the corresponding reference number.

### DETAILED DESCRIPTION OF EMBODIMENTS

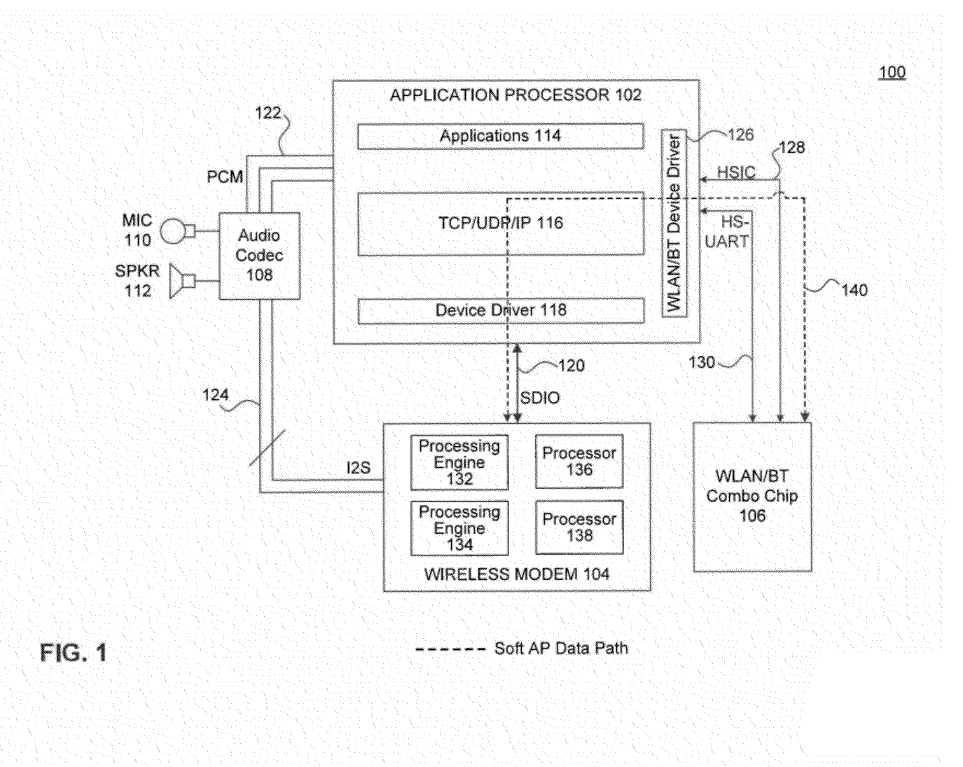

FIG. 1 illustrates an example wireless communications device 100 according to an embodiment of the present disclosure. Example wireless communications device 100 is provided for the purpose of illustration and is not limiting of embodiments of the present disclosure.

Wireless communications device 100 may be a smart phone, for example, which enables data communication (e.g., Internet access, email, smart phone applications, etc.) as well as voice calling. Wireless communications device 100 may support various mobile phone technologies including 2G (e.g., Global System for Mobile Communications (GSM), etc.), 2.5G (e.g., General Packet Radio Service (GPRS), etc.), 3G (e.g., Enhanced Data for GSM Evolution (EDGE), Wideband Code Division Multiple Access (WDMA), CDMA2000, etc.), and 4G (e.g., Long Term Evolution (LTE), WiMAX, etc.) technologies.

As shown in FIG. 1, wireless communications device 100 includes an application processor (AP) 102, a wireless modem 104, a Wireless Local Area Network/Bluetooth (WLAN/BT) combo chip 106, an audio codec module 108, a microphone 110, and a speaker 112.

AP 102 may enable various Internet Protocol (IP)-based applications 114, including data, audio (e.g., voice, streaming music, etc.), and/or video applications. In addition, AP 102 may enable a Hotspot application, which allows wireless communications device 100 to be used as a wireless network access point. To support these applications, AP 102 may implement various protocol stacks, including an “IP” stack 116, which includes the Transmission Control Protocol (TCP) and/or the User Datagrarn Protocol (UDP) over the Internet Protocol (IP).

AP 102 may communicate with audio codec module 108 via an interface 122. Interface 122 may be a Pulse Code Modulation (PCM)-based interface. For example, AP 102 may use interface 122 to send real-time and/or non-real-time digital audio streams to audio codec 108 for processing and playback via speaker 112, for example. AP 102 may also use interface 122 to receive digital audio streams from audio codec 108, resulting from audio captured by microphone 110. The various sent and received digital audio streams may be processed by applications supported by AP 102, including VoIP applications, for example.

AP 102 may also communicate with other external ICs of wireless communications device 100. For example, as shown in FIG. 1, AP 102 includes a device driver 118, which allows AP 102 to interface with wireless modem 104 via an interface 120. In an embodiment, interface 120 is an SDIO (Secure Digital Input Output) interface. In addition, AP 102 includes a WLAN/BT device driver 126, which allows AP 102 to interface with WLAN/BT combo chip 106 via an interface 128. In an embodiment, interface 128 is a High-Speed-Inter-Chip (HSIC) interface. In another embodiment, WLAN/BT device driver 126 further allows AP 102 to interface via a control bus 130 (e.g., High Speed Universal Asynchronous Receiver/Transmitter (HS-UART)) with WLAN/BT chip 106.

In an embodiment, AP 102 uses each of wireless modem 104 and WLAN/BT combo chip 106 as a (data link layer) Layer 2 (L2) pipe that provides L2 functions for IP-based traffic sent and received by AP 102. L2 functions provided by wireless modem 104 or WLAN/BT combo chip 106 may include, without limitation, data link layer functions, Medium Access Control (MAC) layer functions, and Radio Link Control (RLC) functions. In addition, AP 102 may use each of wireless modem 104 and WLAN/BT combo chip 106 for baseband processing functions, including, without limitation, channel encoding/decoding, line coding/decoding, modulation/demodulation, etc. In an embodiment, the functions provided by wireless modem 104 are particular to mobile phone technologies supported by wireless modem 104. Functions provided by WLAN/BT combo chip are particular to WLAN technologies and/or Bluetooth supported by chip 106.

Wireless modem 104 may be a mobile phone modem, which may support a variety of mobile phone technologies, including 2G (e.g., GSM, etc.), 2.5G (e.g., GPRS, etc.), 3G (EDGE, WCDMA, CMDA2000, etc.), and 4G (e.g., LTE, WiMAX, etc.). As shown in FIG. 1, wireless modem 104 includes, without limitation, a processing engine 132, a processing engine 134, a processor 136, and a processor 138. Wireless modem 104 may communicate with AP 102 via interface 120 and with audio codec 108 via an interface 124 (e.g., Integrated Interchip Sound (I2S) interface). In addition, wireless modem 104 may communicate with a Radio Frequency Integrated Circuit (RFIC) module (not shown in FIG. 1), responsible for RF transmission/reception.

Processor 136 is a chip-level general controller of wireless modem 104. Processor 136 may thus perform general housekeeping functions, including boot up, configuration, and management functions. In addition, processor 136 may communicate with various interfaces, such as interface 120, for example.

Processor 138 implements one or more L2 protocol stacks. For example, processor 138 may support various data link layer protocols, MAC layer protocols, and RLC protocols. L2 protocols are defined by mobile phone technologies, including 3G and 4G technologies. Certain L2 protocols may be common to more than one technology. In an embodiment, processor 138 provides an L2 data pipe for AP 102 via interface 120 (and optionally through processing engine 134).

Processing engine 134 implements baseband processing functions, including, without limitation, channel encoding/decoding, line coding/decoding, modulation/demodulation, etc. For example, processing engine 134 may implement a variety of baseband processing functions in accordance with various mobile phone standards, including, for example and without limitation, LTE, WiMAX, EDGE, etc. In an embodiment, processing engine 134 acts as a bridge between processor 138 and the RFIC module (not shown in FIG. 1).

Processing engine 132 implements various speech coding (data compression) functions, including, for example, narrow-band, wide-band, and adaptive multi-rate speech coding functions. Typically, these speech coding functions are defined in mobile phone technology standards. In addition, processing engine 132 may provide other acoustical processing functions, such as noise suppression, echo cancellation, etc. In embodiments, processing engine 132 may be used to process digital audio streams, received from either AP 102 or directly from audio codec 108 over interface 124.

WLAN/BT chip 106 implements a WLAN and/or a Bluetooth protocol stack, which performs (physical layer) Layer 1 (L1) and L2 WLAN/BT functions. WLAN/BT chip 106 may be operated in a Station mode or in a Hotspot mode. In the Station mode, chip 106 scans for a wireless network (e.g., WiFi, Bluetooth, etc.) to connect to as a client. When such a wireless network is found, chip 106 may connect to the wireless network (after required authentication is successful). In this mode, data (e.g., IP) traffic is routed to/from AP 102 through WLAN/BT chip 106, over interface 128, for example. Wireless modem 104 is used for voice calling only in this mode.

In the Hotspot mode, chip 106 enables a wireless network access point host, which allows client devices to connect wirelessly (over a wireless link, such as a WLAN, Bluetooth, etc. link) to chip 106, with network (e.g., Internet) access provided through the mobile phone connection enabled by wireless modem 104. In this mode, client data traffic (e.g., traffic originating or destined to client devices) is routed according to AP data path 140 shown in FIG. 1. In particular, uplink data traffic is received by chip 106 from a client device over the wireless link and is routed as uplink IP packets over interface 128 to AP 102. AP 102 forwards the uplink IP packets to wireless modem 104 over interface 120. Wireless modem 104 performs L2 and L1 processing on the uplink IP packets, before forwarding the resulting uplink bit streams to the RFIC module for transmission over the mobile phone connection.

Downlink traffic is received by wireless modem 104 (from the RFIC module) over the mobile phone connection and is processed by wireless modem 104 to generate downlink IP packets. Wireless modem 104 then forwards the downlink IP packets to AP 102 over interface 120, which in turn forwards the downlink IP packets to chip 106 over interface 128. Chip 106 performs L2 and L1 processing on the downlink packets, before forwarding the resulting downlink bit streams to the RFIC module (or another RFIC dedicated to WLAN/BT chip 106) for transmission to the client device over the wireless link.

In addition to client traffic, a user of wireless communications device 100 may generate local data traffic while chip 106 is operating in the Hotspot mode. This local data traffic is intercepted by IP stack 116 of AP 102 and forwarded to the appropriate one of Applications 114 of AP 102. IP stack 116 thus implements routing functionality for determining whether data traffic is local (e.g., destined to Applications 114 of AP 102) or client traffic (e.g., destined to a client device of chip 106).

Typically, when device 100 is used as an access point, local data (e.g., IP) traffic is minimal or completely absent. For example, in the majority of cases, when device 100 is operated as an access point, the user uses another device (e.g., laptop) for data connectivity via device 100, instead of using device 100 directly. Accordingly, data traffic through device 100 is substantially, if not completely, client traffic destined to client devices of chip 106. Further, in most cases, the user does not use device 100, when operated as an access point, in ways that require processing by AP 102. For example, typically, the user stops interacting with the device through its user interfaces (e.g., buttons, screen, etc.).

Accordingly, AP 102 operates as a mere interface between wireless modem 104 and chip 106, when chip 106 is operated in the Hotspot mode. Nevertheless, AP 102 must stay powered on at all times to enable this functionality between wireless modem 104 and chip 106. This however may result in high power consumption and reduced battery lifetime of device 100. In addition, data connectivity quality may be affected by the latency involved in routing data traffic through AP 102.

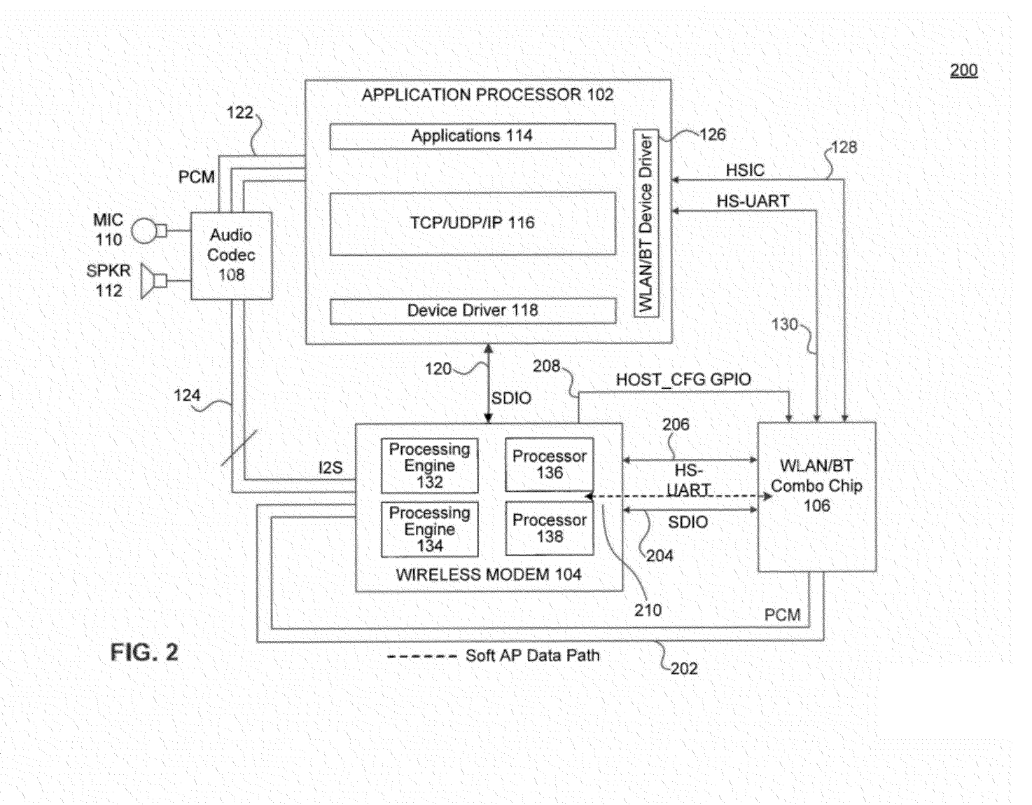

In another embodiment, as described with reference to FIG. 2 below, AP 102 may be bypassed by client data traffic to reduce power consumption. For example, AP 102 may only be involved in the initial Hotspot mode setup of chip 106. Client data traffic however is routed directly between wireless modem 104 and chip 106, without passing through AP 102. As such, the usage of AP 102 is reduced significantly during the Hotspot mode, resulting in increased battery lifetime and reduced power consumption. In addition, AP 102 may be able to enter a power saving mode if no other processing by AP 102 is required.

FIG. 2 illustrates another example wireless communications device 200 according to an embodiment of the present disclosure. Example wireless communications device 200 is provided for the purpose of illustration and is not limiting of embodiments of the present disclosure. As shown in FIG. 2, example device 200 includes similar elements as described above with respect to example device 100. In addition, example device 200 includes a PCM interface 202, a SDIO interface 204, and a HS-UART interface 206 between wireless modem 104 and WLAN/BT combo chip 106.

Example device 200 has similar operation as example device 100, when chip 106 is operated in the Station mode. In particular, data (e.g., IP) traffic is routed to/from AP 102 through WLAN/BT chip 106, over interface 128, for example. Wireless modem 104 is used for voice calling only in this mode.

In the Hotspot mode, in an embodiment, example device 200 may be operated similar to example device 100 as described above. In another embodiment, however, device 200 enables an alternative flow for client traffic, which bypasses AP 102 and allows AP 102 to enter a sleep mode if appropriate. In example device 200, this alternative flow is enabled by SDIO interface 204, which allows client data traffic to be routed according to AP data path 210 shown in FIG. 2.

In particular, uplink data traffic is received by chip 106 from a client device over the wireless link and is routed as uplink IP packets over interface 204 to wireless modem 104. Wireless modem 104 performs L2 and L1 processing on the uplink IP packets, before forwarding the resulting uplink bit streams to the RFIC module for transmission over the mobile phone connection. Downlink traffic is received by wireless modem 104 (from the RFIC module) over the mobile phone connection and is processed by wireless modem 104 to generate downlink IP packets. Wireless modem 104 then forwards the downlink IP packets to chip 106 over interface 204. Chip 106 performs L2 and L1 processing on the downlink packets, before forwarding the resulting downlink bit streams to the RFIC module for transmission to the client device over the wireless link.

In an embodiment, when data traffic through device 200 is made entirely of client traffic and no other processing is required from AP 102, AP 102 enters a sleep mode, resulting in increased battery lifetime and reduced power consumption in device 200. AP 102 may power up when the user tries to interact with device 200. In an embodiment, example device 200 may continue to use the alternative flow for client traffic even when AP 102 is powered up, as long as AP 102 does not generate any local traffic through device 200. Alternatively, example device 200 switches to the traffic flow described with respect to example device 100 (e.g., routing through AP 102) whenever AP 102 is powered up.

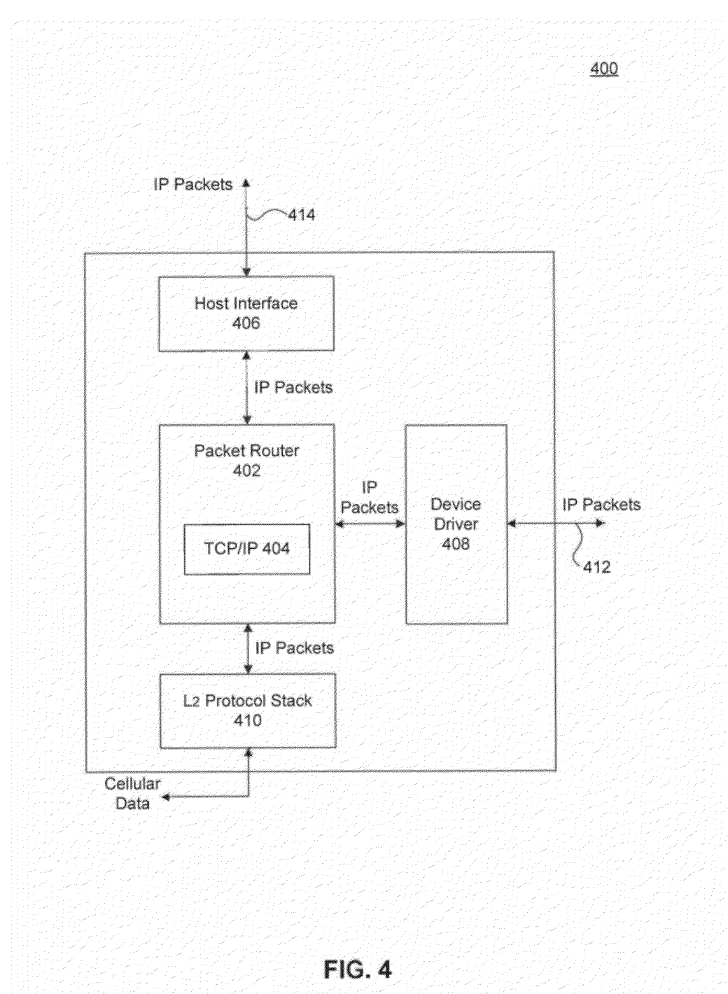

In another embodiment, device 200 continues to use the alternative flow for client traffic (e.g., bypassing AP 102) as long as local traffic is below a predetermined level. In this embodiment, wireless modem 104 (and/or other elements of device 200) enables an IP packet routing functionality that routes client traffic over interface 204 to chip 106 and local traffic over interface 120 to AP 102. An example implementation of such routing functionality is described in FIG. 4 below. When local traffic exceeds the predetermined level, device 200 switches to the traffic flow described with respect to example device 100 above.

In an embodiment, depending on the mode of operation of chip 106 (e.g., Station mode or Hotspot mode) and the traffic flow used (when in the Hotspot mode) in device 200, one or more of interface 128 and interface 204 may be active or inactive. For example, in the Station mode, chip 106 communicates data with AP 102 only. Accordingly, interface 128 is active and interface 204 may be may be tri-stated or inactive to reduce power. Alternatively, in the Hotspot mode, with AP 102 powered down, for example, interface 204 only is active and interface 128 may be tri-stated or inactive to reduce power. In other cases, both interfaces 128 and 204 may be active or inactive at the same time.

In an embodiment, chip 106 is operated in the Station mode or the Hotspot mode by controlling a General Purpose Input/Output (GPIO) pin of chip 106. In an embodiment, as shown in FIG. 2, the GPIO pin is controlled by a HOST_CFG GPIO signal 208 provided by wireless modem 104. In another embodiment, signal 208 is provided by AP 102. Additionally, the GPIO pin may be used to select which of interfaces 128 and 204 should be active/inactive.

HS-UART interface 206 provides a control bus between chip 106 and wireless modem 104. In an embodiment, interface 206 is used to enable wireless co-existence between chip 106 and wireless modem 104, by allowing time coordination of communication events, so as to reduce or eliminate interference between the respectively implemented communication technologies of chip 106 and wireless modem 104. PCM bus 202 allows chip 106 to interface with audio codec 108 via wireless modem 104.

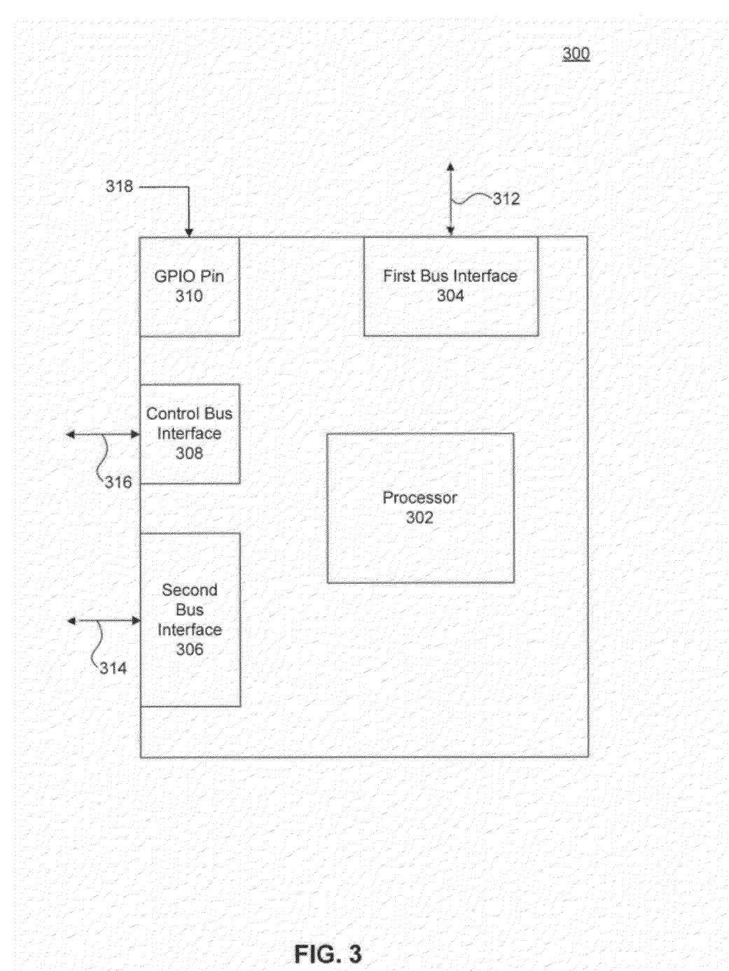

FIG. 3 illustrates an example wireless communications integrated circuit (IC) 300 according to an embodiment of the present disclosure Example wireless communications IC 300 is provided for the purpose of illustration and is not limiting. As would be understood by a person of skill in the art based on the teachings herein, wireless communications IC 300 may be implemented with more or less elements than shown in FIG. 3 in other embodiments.

In an embodiment, wireless communications IC 300 may be a WLAN chip, a Bluetooth chip, or a Combo WLAN/BT chip, such as chip 106. Wireless communications IC 300 may be embedded in a wireless communications device, such as device 100, for example. As shown in FIG. 3, example wireless communications IC 300 includes a processor 302, a first bus interface 304, a second bus interface 306, a control bus interface 308, and GPIO pin 310.

First bus interface 304 and second bus interface 306 each enables wireless communications IC 300 to interface with an external chip or device. For example, in an embodiment, first bus interface 304 allows wireless communications IC 300 to interface, via a first bus 312, with an application processor (AP) of the wireless communications device. Second bus interface 306 allows wireless communications IC 300 to interface, via a second bus 314, with a wireless modem of the wireless communications device. In an embodiment, first bus interface 304 and second bus interface 306 is each configured as a interface or as a SDIO interface.

In an embodiment, both first bus interface 304 and second bus interface 306 are enabled at manufacture time. At operation time, depending on the mode of operation of wireless communications IC 300, one or the other or both of first bus interface 304 and second bus interface 306 may be active.

In an embodiment, wireless communications IC 300 may operate in a Station mode or in a Hotspot mode. In the Station mode, wireless communications IC 300 scans for a wireless network (e.g., WiFi, Bluetooth, etc.) to connect to as a client, and when such a wireless network is found, connects to the wireless network (after required authentication is successful). In the Hotspot mode, wireless communications IC 300 enables a wireless network access point host, which allows other client devices to connect wirelessly to wireless communications IC 300 for network access.

In an embodiment, when wireless communications IC 300 is operating in the Station mode, uplink data traffic is forwarded from the AP to wireless communications IC 300 for transmission over the wireless network. Downlink data traffic is received by wireless communications IC 300 over the wireless network and forwarded to the AP. Thus, wireless communications IC 300 interacts with the AP only, via first bus interface 304, in this mode. Accordingly, second bus interface 306 may be tri-stated or inactive to reduce power.

Alternatively, when wireless communications IC 300 is operating in the Hotspot mode, data traffic may flow between wireless communications IC 300 and the wireless modem via second bus interface 308, without involving the AP as described above in FIG. 2. Accordingly, in this mode, first bus interface 304 may be tri-stated or inactive to reduce power.

In an embodiment, wireless communications IC 300 is operated in the Station mode or the Hotspot mode by controlling GPIO pin 310. In an embodiment, GPIO pin 310 is coupled to a signal 318, which may be provided by the AP or the wireless modem. Signal 318 controls GPIO pin 310 to switch wireless communications IC 300 between the Station mode and the Hotspot mode. Depending on the mode of operation, one of first bus interface 304 and second bus interface 306 is active and the other is inactive.

In an embodiment, signal 318 is provided by the wireless modem, which toggles signal 318 (e.g., from 0 to 1) in response to information from the AP that the user has enabled a Hotspot application. In response to the toggling of signal 318 (and GPIO pin 310), processor 302 power cycles and boots-up in the Hotspot mode. In an embodiment, processor 302 re-boots with first bus interface 304 inactive and second bus interface 306 active in the Hotspot mode. The wireless modem then loads an appropriate firmware onto processor 302 via second bus interface 306, to allow wireless communications IC 300 to communicate over second bus 314 with the wireless modem. In an embodiment, second bus 314 is a SDIO bus, and the wireless modem loads a SDIO interface firmware onto processor 302.

In a similar fashion, when the user exits the Hotspot application, GPIO pin 310 is toggled (e.g., from 1 to 0), which causes processor 302 to re-boot in the Station mode. In an embodiment, processor 302 re-boots with first bus interface 304 active and second bus interface 306 inactive in the Station mode. The AP then loads an appropriate firmware onto processor 302 via first bus interface 304, to allow wireless communications IC 300 to communicate over first bus 314 with the AP. In an embodiment, first bus 312 is a HSIC bus, and the AP loads a HSIC interface firmware onto processor 302.

As shown in FIG. 3, wireless communications IC 300 includes a control bus interface 308, which allows IC 300 to communicate over a control bus 316. In an embodiment, control bus 316 allows IC 300 to communicate control information with the wireless modem. In another embodiment, IC 300 may include other control bus interfaces, which allow IC 300 to communicate control information with other external devices or chips, such as the AP, for example.

In an embodiment, control bus 316 is used to communicate control information to enable wireless co-existence between IC 300 and the wireless modem. For example, IC 300 and the wireless modem may be implementing communication technologies, with nearby operating transmit/receive frequency bands, such as WiFi and LTE. Bus 316 enables IC 300 and the wireless modem to coordinate events in time, so as to operate with no or minimal interference between the respectively implemented communication technologies. For example, when IC 300 is operated in the Station mode, IC 300 may use bus 316 to coordinate with the wireless modem when IC 300 scans for WiFi networks, in order not to be overwhelmed with LTE transmissions by the wireless modem. In an embodiment, control bus 316 is a low rate bus, such as a HS-UART.

FIG. 4 illustrates an example implementation 400 of embodiments of the present disclosure. Example implementation 400 is provided for the purpose of illustration and is not limiting. As would be understood by a person of skill in the art based on the teachings herein, embodiments may be implemented with more or less elements than shown in FIG. 4. In embodiments, example implementation 400 may be implemented, partially or fully, within wireless modem 104 and/or another chip coupled to wireless modem 104 of wireless communications device 100. For example, one or more elements of example implementation 400 may be implemented in processor 136 and/or processor 138 of wireless modem 104. Other elements may be implemented outside of processor 136 and/or 138 within wireless modem 104 or outside of wireless modem 104.

As shown in FIG. 4, example implementation 400 includes a packet router module 402, including a TCP/IP protocol stack 404, a host interface 406, a device driver 408, and a Layer 2 (L2) protocol stack 410. Host interface 406 is configured to connect to a host (e.g., AP 102) via an interface 414. Interface 414 may be a SDIO interface, such as SDIO interface 120. Device driver 408 is configured to connect to a device (e.g., WLAN/BT Combo Chip 106) via an interface 412. Interface 412 may be an SDIO interface, such as SDIO interface 204.

In operation, downlink L2 cellular (e.g., LTE, WiMAX, etc.) data packets are received by L2 protocol stack 410. In an embodiment, protocol stack 410 is implemented on processor 138 of wireless modem 104. L2 packets are processed in protocol stack 410 to produce downlink IP packets. Then, the downlink IP packets are passed to IP packet router module 402.

In an embodiment, IP packet router module 402 is configured to examine downlink IP packets, using TCP/IP protocol stack 404, to determine their destinations. In an embodiment, IP packet router module 402 is configured to determine if a destination address of a downlink IP packet matches a first IP address assigned to the wireless communications device (where IP packet router module 402 is located) or a second IP address assigned to a client device, where the client device is a device wirelessly connected to a wireless network access point host, implemented on the wireless communications device. For example, the wireless network access point host may be implemented on a wireless communications chip of the wireless communications device, such as WLAN/BT Combo Chip 106.

If the destination address of the downlink IP packet matches the first IP address assigned to the wireless communications device, IP packet router module 402 is configured to forward the IP packet to host interface 406. In turn, host interface 406 is configured to forward the IP packet over interface 414 to the host (e.g., AP 102). In the host, the IP packet is de-capsulated and the resulting application layer packet delivered to the appropriate local application.

If the destination address of the downlink IP packet matches the second IP address assigned to the client device, IP packet router module 402 is configured to retrieve a medium access control (MAC) address associated with the second IP address assigned to the client device. In an embodiment, IP packet router module 402 is configured to retrieve the MAC address from a Dynamic Host Configurable Table (DHCP) table, maintained in the wireless communications device.

In an embodiment, a DHCP server module (not shown in FIG. 4) is implemented within the wireless communications device. For example, referring to FIG. 1, the DHCP server module may be implemented within processor 136 and/or processor 138 of wireless modem 104. Alternatively, the DHCP server module is implemented within AP 102. The DHCP server module helps the wireless network access point host (e.g., implemented on a wireless communications chip of the wireless communications device, such as WLAN/BT Combo Chip 106) to enable a wireless network, such as a WLAN (e.g., WiFi) network, a Bluetooth network, etc., as further described below.

When the wireless communications chip (e.g., WLAN/BT Combo Chip 106) is operated in a Hotspot mode, the wireless network access point host begins responding, using the DHCP server module, to DHCP Discover packets from client devices that wish to connect to the wireless network. A DHCP Discover packet is a broadcast packet having an IP section and a DHCP section that identifies the sending device by the physical address of its network card (e.g., MAC address).

When the wireless network access point host receives a DHCP Discover packet, it forwards the DHCP Discover packet to the DHCP server module. The DHCP server module generates a DHCP Offer packet, which includes (among other parameters, e.g., Subnet Mask, Default Gateway, Lease Time, etc.) the IP address that the DHCP server module is offering the client. The DHCP server module forwards the DHCP Offer packet to the wireless network access point host, which broadcasts the DHCP Offer packet.

The client responds to the DHCP Offer packet by broadcasting a DHCP Request packet. The DHCP section of the DHCP Request verifies the offered IP address and the IP address of the DHCP server module. The wireless network access point host receives the DHCP Offer packet and forwards it to the DHCP server module. The DHCP server module generates a DHCP Ack packet, which completes the offered IP address lease. The DHCP server module then forwards the DHCP Ack packet to the wireless network access point host, which broadcasts the DHCP Ack packet.

In an embodiment, the DHCP server module associates the offered IP address with the MAC address of the client in a DHCP table. Thus, the DHCP table provides the IP addresses and MAC addresses of all clients connected to the wireless network enabled by the wireless network access point host, implemented on the wireless communications chip of the wireless communications device.

Returning to FIG. 4, if the downlink IP packet is destined to the client device, IP packet router module 402 is configured to retrieve the MAC address of the client device based on the IP address of the IP packet, from the DHCP table. IP packet router module 402 then forwards the IP packet (or alternatively, the application layer packet encapsulated therein) along with the retrieved MAC address to device driver 408.

In turn, device driver 408 is configured to forward the IP packet (or alternatively, the application layer packet encapsulated therein) along with the retrieved MAC address, over interface 412, to the wireless communications chip, implementing the wireless network access point host. The wireless network access point host uses the MAC address to deliver the embedded application layer packet in a L2 packet to the client. The L2 packet is in accordance with the type of wireless network (e.g., WLAN, Bluetooth, etc.) enabled by the wireless network access point host.

For the uplink, IP packet router module 402 may receive IP packets from the host (e.g., AP 102), originated by local applications running on the host, and/or from the wireless communications chip (e.g., WLAN/BT Combo chip 106), originated by applications running on client devices of the wireless network access point host. IP packet router module 402 forwards the received IP packets to L2 protocol stack 410 for L2 processing and then transmission over the cellular network.

According to the above described mode of operation, IP traffic (downlink and/or uplink) associated with client devices of the wireless network access point host is processed by IP packet router module 402 without involving the host (e.g., AP 102). As a result, when the wireless communications device is only being used to provide a wireless network access point (e.g., the wireless communications device is not also being used by a user in a way that requires host processing), the host can enter a sleep mode resulting in significant power savings for the wireless communications device.

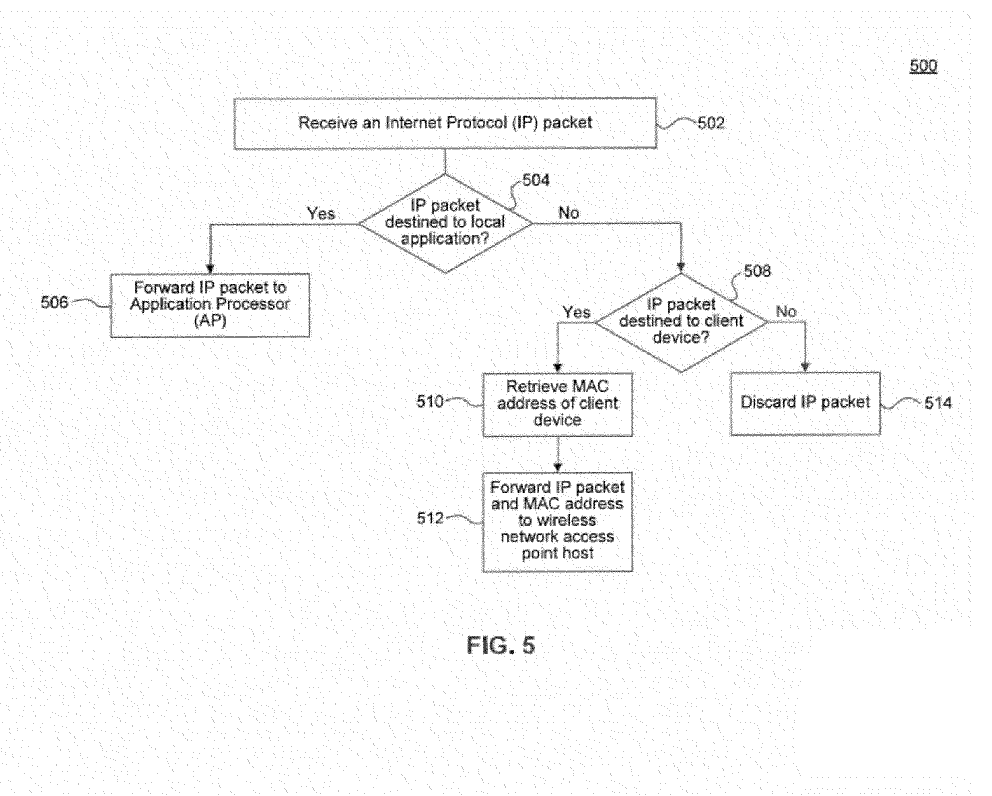

FIG. 5 is a process flowchart 500 of a method of processing packets in a wireless communications device according to an embodiment of the present disclosure. Process 500 may be performed within a wireless modem (e.g., wireless modem 104) of the wireless communications device and/or in another module outside the wireless modem (which may be on the same chip as the wireless modem). For example, process 500 may be performed by example implementation 400 as described above in FIG. 4.

As shown in FIG. 5, process 500 begins in step 502, which includes receiving an IP packet. In an embodiment, step 502 is performed by an IP packet router module (e.g., IP packet router module 402) configured to receive downlink IP packets from an underlying L2 protocol stack, for example.

Subsequently, process 500 proceeds to step 504, which includes determining if the IP packet is destined to a local application running on the wireless communications device. In an embodiment, step 504 determining whether or not a destination address of the IP packet matches an IP address assigned to the wireless communications device. If the IP packet is destined to a local application, process 500 proceeds to step 506, which includes forwarding the IP packet to an Application Processor (AP) of the wireless communications device. Otherwise, process 500 proceeds to step 508.

Step 508 includes determining whether or not the IP packet is destined to a client device, wirelessly connected to the wireless communications device via a wireless network access point host enabled on the wireless communications device. In an embodiment, the wireless network access point host is running on a wireless communications chip (e.g., WLAN/BT Combo Chip 106) operated in a Hotspot mode. In an embodiment, step 508 includes checking the destination address of the IP packet against a list of IP addresses associated with client devices. In an embodiment, the list of IP addresses is part of a DHCP table maintained by a DHCP server module of the wireless communications device.

If the IP packet is not destined to a client device, process 500 proceeds to step 514, in which the IP packet is discarded. Otherwise, process 500 proceeds to step 510, which includes retrieving a MAC address of the client device. In an embodiment, the MAC address of the client device is retrieved from the DHCP table based on the destination IP address of the IP packet (which, in this case, matches the IP address assigned to the client by the DHCP ver module).

Finally, in step 512, the IP packet (or alternatively, the application layer packet encapsulated therein) is forwarded to the wireless network access point host, along with the MAC address of the client device. In an embodiment, step 512 is performed without passing through or involving the AP, which may enter a sleep mode. The wireless network access point host uses the MAC address to deliver the embedded application layer packet in a L2 packet to the client device. The L2 packet is in accordance with the type of wireless network (e.g., WLAN, Bluetooth, etc.) enabled by the wireless network access point host.

It will be apparent to persons skilled in the relevant art(s) that various elements and features of the present disclosure, as described herein, can be implemented in hardware using analog and/or digital circuits, in software, through the execution of instructions by one or more general purpose or special-purpose processors, or as a combination of hardware and software.

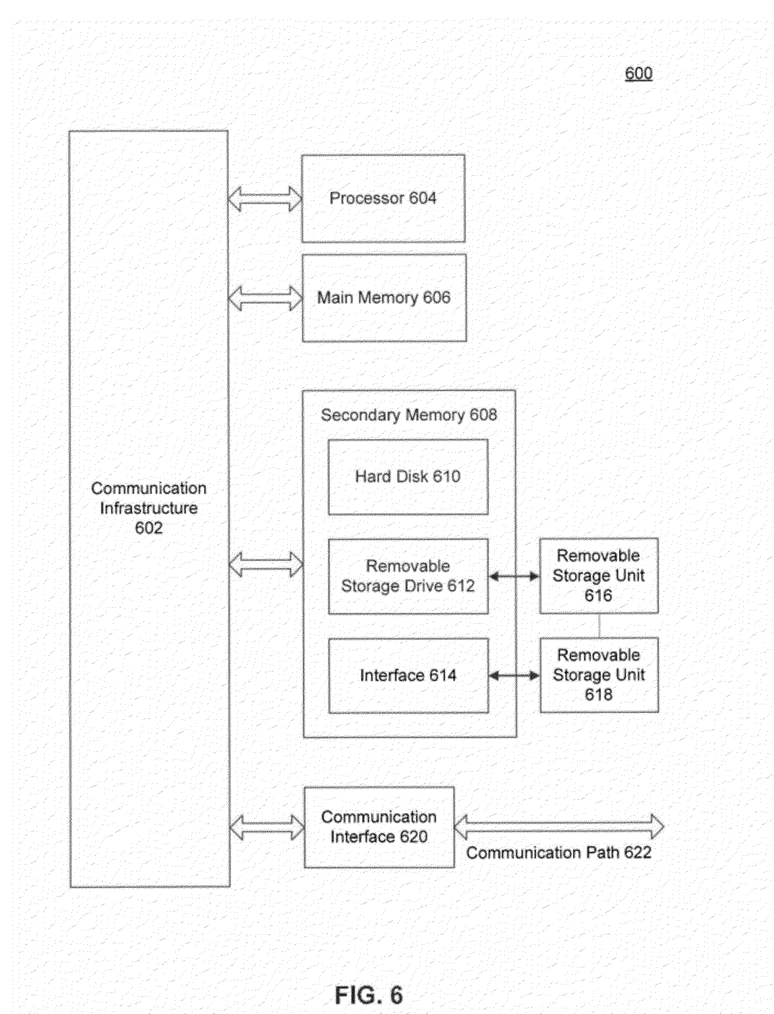

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. An example of such a computer system 600 is shown in FIG. 6. Modules depicted in FIGS. 1-4 may execute on one or more computer systems 600. Furthermore, each of the steps of the flowchart depicted in FIG. 5 can be implemented on one or more computer systems 600.

Computer system 600 includes one or more processors, such as processor 604. Processor 604 can be a special purpose or a general purpose digital signal processor. Processor 604 is connected to a communication infrastructure 602 (for example, a bus or network). Various software implementations are described in terms of this exemplary computer system. After reading this description, it will become apparent to a person skilled in the relevant art(s) how to implement the disclosure using other computer systems and/or computer architectures.

Computer system 600 also includes a main memory 606, preferably random access memory (RAM), and may also include a secondary memory 608. Secondary memory 608 may include, for example, a hard disk drive 610 and/or a removable storage drive 612, representing a floppy disk drive, a magnetic tape drive, an optical disk drive, or the like. Removable storage drive 612 reads from and/or writes to a removable storage unit 616 in a well-known manner. Removable storage unit 616 represents a floppy disk, magnetic tape, optical disk, or the like, which is read by and written to by removable storage drive 612. As will be appreciated by persons skilled in the relevant art(s), removable storage unit 616 includes a computer usable storage medium having stored therein computer software and/or data.

In alternative implementations, secondary memory 608 may include other similar means for allowing computer programs or other instructions to be loaded into computer system 600. Such means may include, for example, a removable storage unit 618 and an interface 614. Examples of such means may include a program cartridge and cartridge interface (such as that found in video game devices), a removable memory chip (such as an EPROM, or PROM) and associated socket, a thumb drive and USB port, and other removable storage units 618 and interfaces 614 which allow software and data to be transferred from removable storage unit 618 to computer system 600.

Computer system 600 may also include a communications interface 620. Communications interface 620 allows software and data to be transferred between computer system 600 and external devices. Examples of communications interface 620 may include a modem, a network interface (such as an Ethernet card), a communications port, a PCMCIA slot and card, etc. Software and data transferred via communications interface 620 are in the form of signals which may be electronic, electromagnetic, optical, or other signals capable of being received by communications interface 620. These signals are provided to communications interface 620 via a communications path 622. Communications path 622 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 616 and 618 or a hard disk installed in hard disk drive 610. These computer program products are means for providing software to computer system 600.

Computer programs (also called computer control logic) are stored in main memory 606 and/or secondary memory 608. Computer programs may also be received via communications interlace 620. Such computer programs, when executed, enable the computer system 600 to implement the present disclosure as discussed herein. In particular, the computer programs, when executed, enable processor 604 to implement the processes of the present disclosure, such as any of the methods described herein. Accordingly, such computer programs represent controllers of the computer system 600. Where the disclosure is implemented using software, the software may be stored in a computer program product and loaded into computer system 600 using removable storage drive 612, interface 614, or communications interface 620.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present disclosure should not be limited by any of the above-described exemplary embodiments, but should be defined only in accordance with the following claims and their equivalents.

What is claimed is:

1. A wireless communications device, comprising:
an application processor (AP) configured to execute at least one local application; and
a processor, located outside of the AP, configured to implement an Internet Protocol (IP) packet router module,
wherein the IP packet router module is configured to receive an IP packet and to forward the IP packet to the AP if the IP packet is destined to the at least one local application, and to forward the IP packet to a wireless network access point host if the IP packet is destined to a client device of the wireless network access point host.

2. The wireless communications device of claim 1, wherein the IP packet is destined to the client device, and wherein the IP packet router module is configured to forward the IP packet to the wireless network access point host without passing through the AP.

3. The wireless communications device of claim 1, wherein the IP packet router module is further configured to determine if a destination address of the IP packet matches a first IP address assigned to the wireless communications device or a second IP address assigned to the client device.

4. The wireless communications device of claim 3, wherein the destination address of the IP packet matches the second IP address assigned to the client device, the IP packet router module further configured to retrieve a medium access control (MAC) address associated with the second IP address assigned to the client device.

5. The wireless communications device of claim 4, wherein the IP packet router module is configured to retrieve the MAC address from a Dynamic Host Configurable Table (DHCP) table.

6. The wireless communications device of claim 5, wherein the processor is further configured to implement a DHCP server module, the DHCP server module configured to assign the second IP address to the client device upon a DHCP request from the client device to the wireless access point host.

7. The wireless communications device of claim 4, wherein the IP packet router module is further configured to forward the MAC address, along with the IP packet, to the wireless network access point host.

8. The wireless communications device of claim 1, wherein the IP packet router module is configured to implement an IP protocol stack.

9. The wireless communications device of claim 1, further comprising:
a wireless communications integrated circuit (IC), wherein the wireless network access point host is implemented on the wireless communications IC.

10. The wireless communications device of claim 9, wherein the wireless network access point host enables at least one of a Wireless Local Area Network (WLAN) and a Bluetooth network.

11. The wireless communications device of claim 1, wherein the processor is located inside a wireless modem of the wireless communications device.

12. The wireless communications device of claim 1, wherein the wireless modem enables a cellular phone technology.

13. A method for processing packets in a wireless communications device, comprising:
receiving an Internet Protocol (IP) packet;
determining whether the IP packet is destined to at least one local application of the wireless communications device or to a client device of the wireless communications device;
forwarding the IP packet to an Application Processor (AP) of the wireless communications device if the IP packet is destined to the at least one local application; and
forwarding the IP packet to a wireless network access point host of the wireless communications device if the IP packet is destined to the client device.

14. The method of claim 13, wherein the IP packet is destined to the client device, and wherein forwarding the IP packet to the wireless network access point host comprises forwarding the IP packet to the wireless network access point host, without passing through the AP.

15. The method of claim 13, wherein said determining comprises determining if a destination address of the IP packet matches a first IP address assigned to the wireless communications device or a second IP address assigned to the client device.

16. The method of claim 15, wherein the destination address of the IP packet matches the second IP address assigned to the client device, further comprising:
retrieving a medium access control (MAC) address associated with the second IP address assigned to the client device.

17. The method of claim 13, wherein the method is performed within a wireless modem of the wireless communications device, and wherein the wireless network access point host is located in a wireless communications integrated circuit (IC) of the wireless communications device.

18. The method of claim 17, wherein the wireless modem enables a cellular phone technology.

19. The method of claim 17, wherein the wireless communications IC enables at least one of a Wireless Local Area Network (WLAN) and Bluetooth network.

20. A wireless communications device, comprising:
an application processor (AP);
a wireless communications integrated circuit (IC) configured to execute a wireless network access point host; and
a wireless modem configured to implement a packet router module,
wherein packet router module is configured to receive a packet and to forward the packet to the AP if the packet is destined to an application executing on the AP, and to forward the packet to the wireless communications IC if the packet is destined to a client device of the wireless network access point host.
